(19) United States
(12) Patent Application Publication
(10) Pub. No.: US 2016/0149802 A1
(43) Pub. Date: May 26, 2016

(54) APPARATUS AND METHOD FOR PROTECTION SWITCHING IN SHARED MESH NETWORK

(71) Applicant: ELECTRONICS AND TELECOMMUNICATIONS RESEARCH INSTITUTE, Daejeon (KR)

(72) Inventors: Ji Wook YOUN, Daejeon (KR); Jeong Dong RYOO, Daejeon (KR); Tae Sik CHEUNG, Daejeon (KR); Ho Geon KIM, Daejeon (KR); Seung Woo LEE, Daejeon (KR)

(21) Appl. No.: 14/926,273

(22) Filed: Oct. 29, 2015

(30) Foreign Application Priority Data
Nov. 24, 2014 (KR) 10-2014-0164750
Jul. 28, 2015 (KR) 10-2015-0106254

(51) Int. Cl. H04L 12/707; H04Q 11/00

(52) U.S. Cl. CPC H04L 45/22; H04Q 11/0066; H04Q 11/0003; H04Q 2011/0081; H04Q 2011/0086

(57) ABSTRACT

A communication terminal performing protection switching in a shared mesh network is provided. The communication terminal configured to transmit and receive data traffic associated with a first working path may include a processor configured to encode, in an optical channel data unit (ODU) including the data traffic, a first operation command message to be received from a first end node, and a communicator configured to transmit the ODU to a neighboring node, in which the first end node is present in a second working path.

### CROSS-REFERENCE TO RELATED APPLICATIONS

This application claims the priority benefits of Korean Patent Application No. 10-2014-0164750, filed on Nov. 24, 2014, and Korean Patent Application No. 10-2015-0106254, filed on Jul. 28, 2015, in the Korean Intellectual Property Office, the disclosures of which are incorporated herein by reference.

### BACKGROUND

1. Field of the Invention

Embodiments relate to an apparatus and a method for protection switching, and more particularly, to an apparatus and a method for protection switching in a shared mesh network.

2. Description of the Related Art

An optical transport network (OTN) has been developed to increase a data transmission capacity to meet an increased quantity of packet data, and also to use a network structure and network resources more effectively. Thus, the ONT has been changing from a conventional simple point-to-point type or a linear type network structure to a shared mesh type network structure.

In a case of protection switching for an optical channel data unit (ODU) in a shared mesh network, different protection paths may share a same protection switching resource. Here, when a protection path uses the shared resource, another protection path may not transmit and receive an operation command message used for a protection switching operation among end nodes, for example, a head end node and a tail end node, through the occupied shared resource.

### SUMMARY

According to an aspect, there is provided a communication terminal configured to transmit and receive data traffic associated with a first working path, the communication terminal including a processor configured to encode, in an optical channel data unit (ODU) including the data traffic, a first operation command message to be received from a first end node, and a communicator configured to transmit the ODU to a neighboring node. The first end node may be present in a second working path. The processor may encode, in the ODU, a connection identifier field value associated with the second working path. The communicator may receive, as the first operation command message, any one of a lockout of protection (LoP) message, an exercise (EXER) message, a reverse request (RR) message, and a no request (NR) message.

The communicator may transmit the ODU to a second end node present in the second working path. The communicator may receive a second operation command message corresponding to the first operation command message from the second end node, and transmit the second operation command message to the first end node present in the second working path.

The processor may encode the first operation command message in a high order ODU. The processor may encode the first operation command message in an automatic protection switching/protection communication channel (APS/PCC) field of the high order ODU.

According to another aspect, there is provided a communication terminal including a processor configured to extract a first operation command message from a first ODU to be received, execute a command corresponding to the extracted first operation command message, and encode a response message corresponding to the first operation command message in a second ODU, and a communicator configured to transmit the second ODU to a node. The node may be included in a shared mesh network for protection switching of a plurality of working paths, and the first ODU may be to be received from the node.

The processor may encode, as the response message in the second ODU, a second operation command message corresponding to the first operation command message. The processor may encode, in the second ODU, a connection identifier field value associated with the second operation command message.

The processor may encode, in the second ODU, an initial state message as the response message. The processor may encode, in the second ODU, a connection identifier field value indicating all of the working paths.

According to still another aspect, there is provided a method of performing protection switching by a first node included in a shared mesh network, the method including receiving a first operation command message from a first end node connected to the shared mesh network, encoding the first operation command message in an ODU to be transmitted and received through the shared mesh network, and transmitting the ODU to a neighboring node.

The transmitting may include transmitting the ODU to a second end node corresponding to the first end node. The transmitting may include transmitting the ODU to a second node included in the shared mesh network.

The method may further include encoding, in the ODU, first data traffic associated with a first working path for which the protection switching is performed through the shared mesh network. The encoding may include encoding the first operation command message in a high order ODU. The encoding may include encoding the first operation command message in an APS/PCC field of the high order ODU.

The method may further include receiving a response message corresponding to the first operation command message from the neighboring node, and transmitting the response message to the first end node. The receiving of the response message may include receiving, as the response message, any one of an initial state message and a second operation command message corresponding to the first operation command message.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an example of a shared mesh network according to an embodiment;

FIG. 2 is a diagram illustrating an example of a communication terminal according to an embodiment;

FIG. 3 is a diagram illustrating an example of an optical channel data unit (ODU) according to an embodiment;

FIG. 4 is a diagram illustrating another example of a communication terminal according to an embodiment;

FIGS. 5A and 5B illustrate an example of a signal flow in a shared mesh network according to an embodiment;

FIG. 6 illustrates another example of a signal flow in a shared mesh network according to an embodiment; and

FIG. 7 is a flowchart illustrating a method of performing protection switching by a first node included in a shared mesh network according to an embodiment.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

Some terms used herein are selected according to a preference of an inventor(s), customs, and technological development and change. Thus, terms used herein are not used to limit the technical features provided herein, but should be understood as only illustrative terms to describe embodiments.

Unless otherwise defined, all terms including technical and scientific terms used herein have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

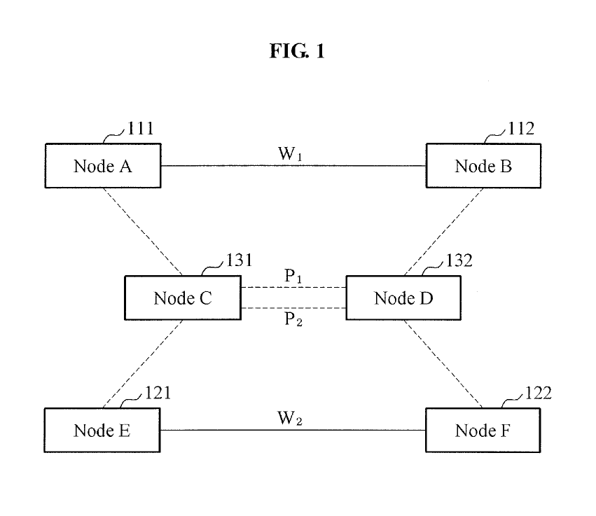

FIG. 1 is a diagram illustrating an example of a shared mesh network according to an embodiment. Referring to FIG. 1, a first working path W₁ connects a first end node A 111 and a second end node B 112. To connect the first end node A 111 and the second end node B 112, protection switching is performed through a first protection path P₁. The first protection path P₁ includes the first end node A 111, a first node C 131, a second node D 132, and the second end node B 112. In addition, a second working path W₂ connects a third end node E 121 and a fourth end node F 122. Similarly, to connect the third end node E 121 and the fourth end node F 122, protection switching is performed through a second protection path P₂. The second protection path P₂ includes the third end node E 121, the first node C 131, the second node D 132, and the fourth end node F 122. In the shared mesh network more stably transmitting data traffic and effectively using communication resources, communication terminals that share a partial path, for example, the first protection path P₁ and the second protection path P₂, and share a portion of communication resources configuring the paths may be present.

When a communication resource of the first working path W₁ is available, the first end node A 111 and the second end node B 112 may transmit and receive data traffic through the first working path W₁. However, when a failure event indicating that the communication resource of the first working path W₁ is unavailable occurs, the first end node A 111 and the second end node B 112 may need to transmit and receive the data traffic using the first protection path P₁. For example, the failure event may indicate any one of an occurrence of signal failure (SF), manual switching (MS), and forced switching (FS).

In an example, a path between the first node C 131 and the second node D 132, which is a portion of the first protection path P₁, may include a plurality of tributary slots (TSs). For example, when the first protection path P₁ uses five TSs, for example, TS1, TS2, TS3, TS4, and TS5, present between the first node C 131 and the second node D 132. In more detail, the first protection P₁ uses the five TSs TS1 through TS5 to transmit and receive data traffic, and the second protection path P₂ connecting the third end node E 121 and the fourth end node F 122 shares at least one of the five TSs TS1 through TS5 used by the first protection path P₁, transmitting and receiving an operation command message associated with the second working path W₂ using the TSs occupied by the first protection path P₁ may not be readily performed. In a case of a conventional apparatus and method for shared mesh protection switching for an optical channel data unit (ODU), such an issue may occur because request messages including an operation command message are transmitted using all TSs forming a protection path. In the conventional method, the request messages may be encoded in an automatic protection switching/protection communication channel (APS/PCC) overhead field in an ODU frame.

Example embodiments to be described hereinafter provide a message configuration for separating an operation command message including a command by an operator from the request messages, and separately encoding the operation command message and transmitting the encoded message. The operation command message may be encoded in an APS/PCC field of a high order ODU that may be permanently available in a protection path included in a shared mesh network.

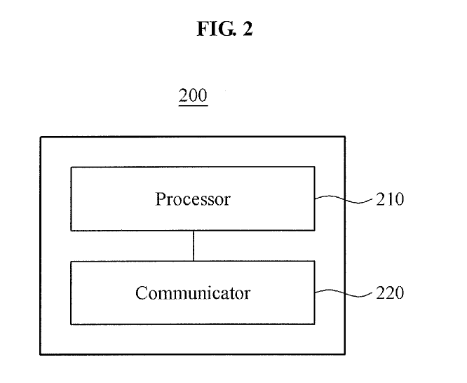

FIG. 2 is a diagram illustrating an example of a communication terminal 200 according to an embodiment. Referring to FIG. 2, the communication terminal 200 includes a processor 210 and a communicator 220. The communication terminal 200 may transmit and receive data traffic associated with a first working path. The communication terminal 200 may include at least one protection path in a shared mesh network. Thus, when a failure event occurs in the first working path and usage of a communication resource is not available, the communication terminal 200 may perform protection switching by transmitting and receiving the data traffic associated with the first working path, as a portion of a first protection path. The data traffic may be encoded in a first ODU, and transmitted and received through the communication terminal 200.

The processor 210 may encode, in the first ODU, a first operation command message to be received from a first end node. For example, the first end node may be an end node connected to a second end node through a second working path. The processor 210 may extract the first operation command message from the first ODU to be received from the first end node.

Table 1 illustrates general request or state messages, and corresponding values used in a conventional apparatus and method for protection switching in a shared mesh network.

TABLE 1

| Field | Value | Description |
|---|---|---|
| Request/state | 1111 | Lockout of protection (LoP) |
| | 1110 | Forced switch (FS) |
| | 1100 | Signal fail (SF) |
| | 1010 | Signal degrade (SD) |
| | 1000 | Manual switch (MS) |
| | 0110 | Wait-to-restore (WTR) |
| | 0100 | Exercise (EXER) |
| | 0010 | Reverse request (RR) |
| | 0001 | Do not revert (DNR) |
| | 0000 | No request (NR) |
| | Others | Reserved |

The processor 210 may extract an operation command message including a command made by an operator from a plurality of request messages, and encode the extracted message as a separate message. An operation command, which is not a real-time request message, indicates a command manually made by an operator only in a case that the operation command is needed. In addition, the operation command may be generated when data traffic affected by a command is being transmitted through a working path, and may not be generated when the data traffic is being transmitted through a protection path. When separating an operation command message from among the request messages illustrated in Table 1, the processor 210 may separate LoP, EXER, RR, and NR messages as operation command messages.

Here, the LoP message is a message to block an access of end nodes to a protection path. When the LoP message is transferred, the end nodes may not transmit and receive data through the protection path irrespective of a communication environment of a working path, and may use only the working path. In addition, the EXER message is a message performing a function of determining whether the access to the protection path is available irrespective of the transmitting and the receiving of the data traffic through the working path. The RR message indicates an acknowledgement (ACK) signal indicating that a request message is transferred to an end node and well received. The RR message is a message among the end nodes to transfer an ACK indicating that a first transferred request message is well received. The NR message is a message transferred among the end nodes when usage of the protection path is not necessary. As necessary, the end nodes may transmit and receive data traffic again using the protection path at anytime.

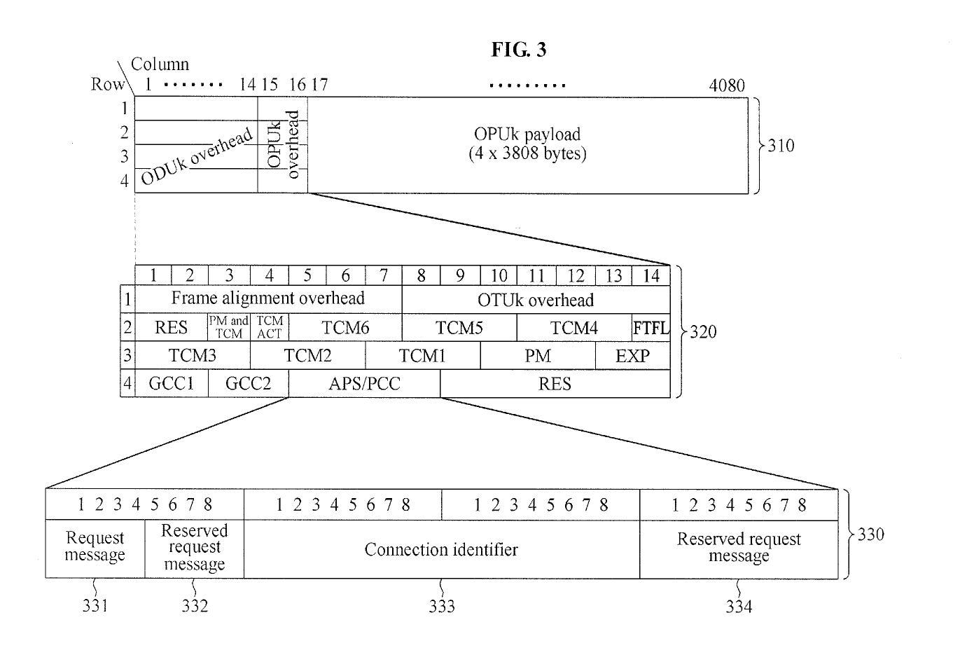

The processor 210 may encode the extracted first operation command message in a high order ODU. In detail, the processor 210 may encode the first operation command message in an APS/PCC field of the high order ODU. In addition, the processor 210 may encode, in the first ODU, a connection identifier field value associated with the second working path. In such a case, a communication terminal receiving the first ODU may determine which working path the received first operation command message is associated with using the connection identifier field value. A structure of an ODU and a process through which an operation command message and a connection identifier field value are encoded will be described in detail with reference to FIG. 3.

The communicator 220 may receive the first operation command message from the first end node. As described in the foregoing, the first end node may be a node included in the second working path. In detail, the communicator 220 may receive, as the first operation command message, any one of the LoP message, the EXER message, the RR message, and the NR message. In addition, the communicator 220 may transmit, to a neighboring node, the first ODU in which the first operation command message and the connection identifier field value are encoded by the processor 210. In an example, the communicator 220 may transmit the first operation command message to the second end node present in the second working path.

In such an example, the second end node may receive the first operation command message from the communicator 220, and execute a corresponding command. In addition, the second end node may encode, in a second ODU, a second operation command message corresponding to the first operation command message and transmit, to the first end node, the second ODU in which the second operation command message is encoded. Here, the communication terminal 200 may also transmit and receive the second ODU transferring the second operation command message, in addition to the first ODU. The communicator 220 may receive, from the second end node, the second operation command message corresponding to the first operation command message, and transmit the second operation command message to the first end node present in the second working path.

FIG. 3 is a diagram illustrating an example of an ODUk 310 according to an embodiment. Referring to FIG. 3, the ODUk 310 includes an optical channel data unit k (ODUk) overhead 320, an optical channel payload unit k (OPUk) overhead, and an OPUk payload. Although the OPUk payload is illustrated as 4×3808 bytes as an example, it may be obvious to a person having an ordinary skill in the art that a byte size may change depending on a structure or a size of a shared mesh network. The ODUk overhead 320 is illustrated to be in a structure including 3 rows and 14 columns. In a case of the ODUk 310 including data traffic, information about protection switching of a first working path associated with transmission and reception of the data traffic may be encoded in an APS/PCC field 330.

In a case of a need for an operation command message associated with protection switching of a second working path to be transmitted and received, the operation command message may be encoded in the ODUk 310 to be transmitted and received. In detail, the operation command message may be encoded in the APS/PCC field 330 of a high order ODUk overhead 320 which is permanently available in a protection path in a shared mesh network. The operation command message may be generated by an operator only when the operation command message needs to be transmitted and received. When the transmission and reception of the operation command message among end nodes associated with the operation command message are verified, the transmission of the operation command message may be suspended and an initial state message may be transmitted. The operation command message may not be a real-time message, but a message to be sent only when necessary. Thus, the operation command message may be transmitted using a frame, which is not in a form of a multi-frame, of the ODUk 310, and messages having different connection identifiers may be transmitted using the same high order ODUk overhead 320.

As illustrated in FIG. 3, the APS/PCC field 330 includes a request message field 331, a first reserved request message field 332, a connection identifier field 333, and a second reserved request message field 334. In an example, the operation command message may be encoded in the request message field 331. In addition, connection information associated with the operation command message may be encoded in the connection identifier field 333. For example, the connection information is information indicating any one of the first working path and the second working path. A structure of the ODUk 310 illustrated in FIG. 3 is provided as an illustrative structure, and may not limit a claim scope of the present invention. Also, it is obvious to a person having ordinary skill in the art that various modifications may be made to a location of each field included in the ODUk 310 and a number of bytes based on a structure and a size of a shared mesh network.

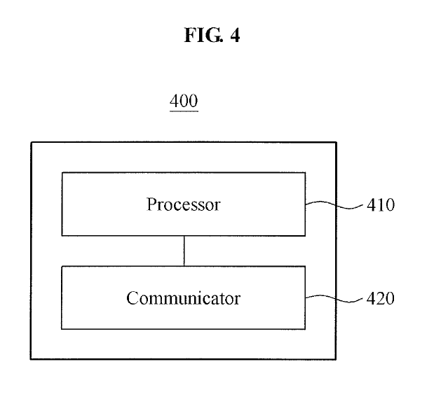

FIG. 4 is a diagram illustrating another example of a communication terminal 400 according to an embodiment. The communication terminal 400 may be included in an end node corresponding to one of a plurality of working paths. Referring to FIG. 4, the communication terminal 400 includes a processor 410 and a communicator 420. The processor 410 may extract a first operation command message from a first ODU to be received. The processor 410 may perform a command corresponding to the extracted first operation command message. For example, the command may be associated with changing a path through which data traffic is transmitted and received. The processor 410 may encode, in a second ODU, a response message corresponding to the first operation command message. In an example, the processor 410 may encode, in the second ODU, an initial state message as the response message. In detail, the initial state message may include an NR message as an operation command message, and include 0 as a connection identifier. Here, “0” may be an example of a connection identifier field value indicating an entirety of the working paths. The initial state message may be transferred to provide a notification to communication terminals associated with all the working paths that usage of a protection path is available at anytime because no request corresponding to the protection path exists. In another example, the processor 410 may encode, as a response message in the second ODU, a second operation command message corresponding to the first operation command message. The processor 410 may encode, in the second ODU, a connection identifier field value associated with the second operation command message.

The communicator 420 may receive the first ODU from a neighboring node. The neighboring node may be a node included in the shared mesh network for protection switching of the working paths. The communicator 420 may transmit, to the neighboring node, the second ODU obtained through the encoding by the processor 410.

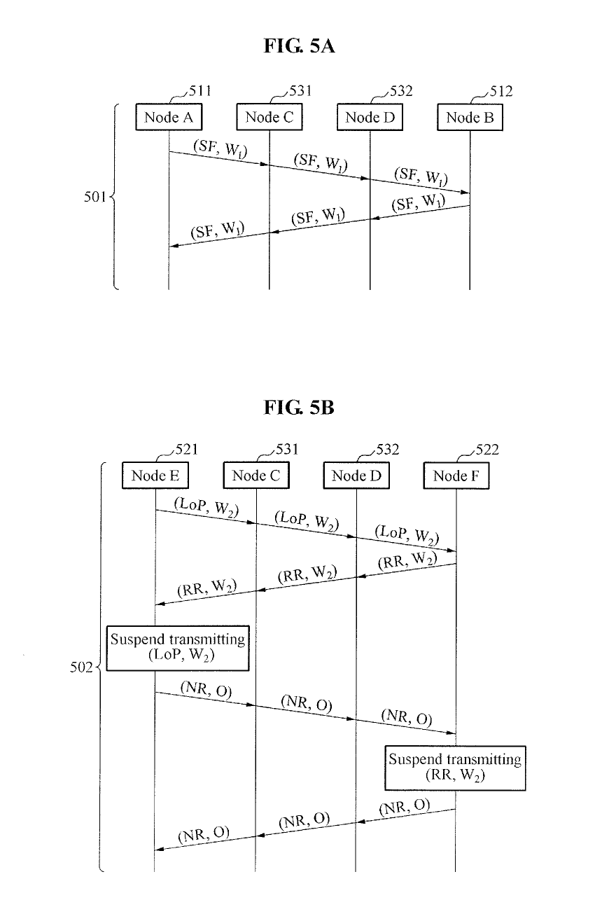

FIGS. 5A and 5B illustrate an example of a signal flow in a shared mesh network according to an embodiment. Referring to FIG. 5A, a first protection path 501 in a shared mesh network includes a first end node A 511, a first node C 531, a second node D 532, and a second end node B 512. When a failure occurs in a first working path W₁ including the first end node A 511 and the second end node B 512, protection switching may be performed through the first protection path 501, and data traffic being transmitted through the first working path W₁ may be transmitted through the first protection path 501. To provide a notification of a failure state of the first working path W₁, the first end node A 511 may transmit, to the second end node B 512, an operation command message indicating SF through the first protection path 501. In addition, the first end node A 511 may transmit, to the second end node B 512, a connection identifier field value associated with the first working path W₁ along with the operation command message indicating SF through the first protection path 501. In such a case, the second end node B 512 may receive a (SF, W₁) message and transmit the (SF, W₁) message again indicating that the (SF, W₁) message is well received to the first end node A 511 through the first protection path 501.

Referring to FIG. 5B, a second protection path 502 in the shared mesh network includes a third end node E 521, the first node C 531, the second node D 532, and a fourth end node F 522. Here, the first protection path 501 and the second protection path 502 in the shared mesh network are assumed to share a portion or an entirety of resources of the shared mesh network. Under the assumption, the third end node E 521 may transmit an operation command message using an ODU with which data traffic is being transmitted. Thus, the third end node E 521 may transmit, to the first node C 531, the operation command message and a connection identifier field value (LoP, W₂) using the ODU. The first node C 531 may verify the operation command message and the connection identifier field value, and transmit a (LoP, W₂) message to the second node D 532. Similarly, the second node D 532 may verify the operation command message and the connection identifier field value, and transmit the (LoP, W₂) message to the fourth end node F 522.

The fourth end node F 522 may receive the (LoP, W₂) message, and execute an LoP command. The fourth end node F 522 may transmit a (RR, W₂) message corresponding to the (LoP, W₂) message to the third end node E 521 through the second node D 532 and the first node C 531. When the third end node E 521 receives the (RR, W₂) message, the third end node E 521 may become aware that the (LoP, W₂) message is successfully transferred to the fourth end node F 522. Thus, the third end node E 521 may suspend transmitting of the (LoP, W₂) message. In addition, the third end node E 521 may transmit a (NR, 0) message to the fourth end node F 522 through the first node C 531 and the second node D 532. Similarly, when the fourth end node F 522 receives the (NR, 0) message, the fourth end node F 522 may suspend transmitting the (RR, W₂) message and transmit the (NR, 0) message. That is, when successful transmission and reception of the LoP message is verified, the both end nodes 521 and 522 using the second protection path 502 may suspend transmitting the operation command message, and transmit and receive the (NR, 0) message which is an initial state message. However, when data traffic associated with the first working path W₁ is still being transmitted and received, the first node C 531 and the second node D 532 which are shared nodes in the protection paths 501 and 502 may transmit the (SF, W₁) message instead of the (NR, 0) message.

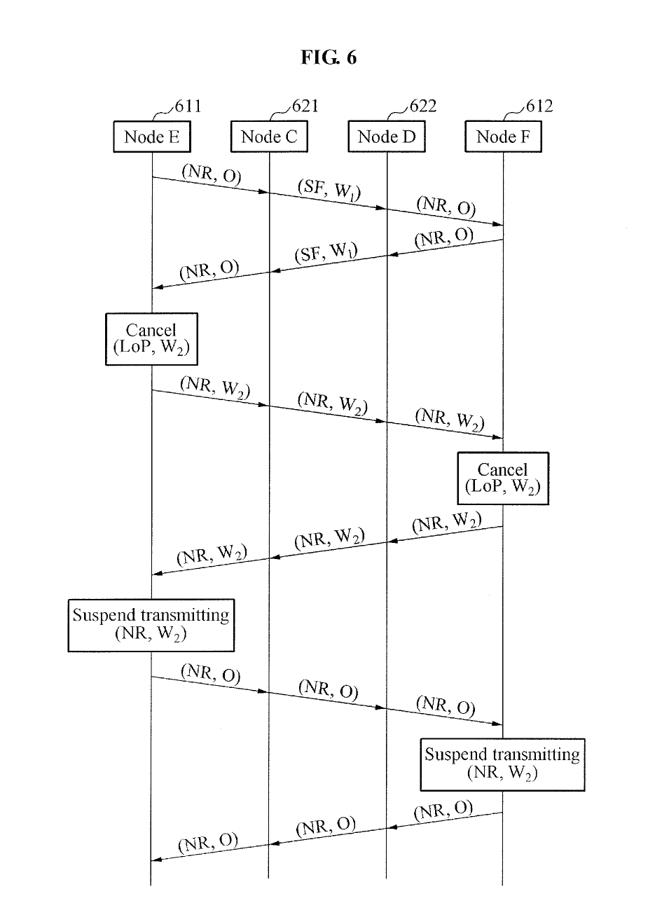

FIG. 6 illustrates another example of a signal flow in a shared mesh network according to an embodiment. Similarly to the example illustrated in FIG. 5, FIG. 6 illustrates a signal flow to cancel an LoP command after the LoP command is executed with respect to a second working path W₂. As described with reference to FIG. 5, referring to FIG. 6, when the LoP command is executed with respect to the second working path W₂, a third end node E 611 and a fourth end node F 612 may transmit and receive a (NR, 0) message which is an initial state message. However, when data traffic associated with a first working path W₁ is still being transmitted and received through a first protection path, a first node C 621 and a second node D 622 may mutually transmit and receive a (SF, W₁) message.

The third end node E 611 may transmit, to the fourth end node F 612, an NR operation command message to cancel transmission and reception of a (LoP, W₂) message. In detail, the third end node E 611 may transmit a (NR, W₂) message to the fourth end node F 612 through the first node C 621 and the second node D 622. When the first node C 621 and the second node D 622, which are shared nodes, are transmitting the (SF, W₁) message, which is a request message associated with the first working path W₁, through an APS field of a high order ODUk overhead, the first node C 621 and the second node D 622 may temporarily suspend transmitting the (SF, W₁) message and transmit the (NR, W₂) message in response to the received (NR, W₂) message. When the fourth end node F 612 receives the (NR, W₂) message, the fourth end node F 612 may recognize cancellation of the LoP associated with the second working path W₂ of the third end node E 611 separate from the fourth end node F 612. Similarly, the fourth end node F 612 may also cancel the LoP associated with the second working path W₂ and transmit, to the third end node E 611, the (NR, W₂) message as a response message in response to the cancellation of the LoP. In detail, the fourth end node F 612 may transmit the (NR, W₂) message to the third end node E 611 through the second node D 622 and the first node C 621. When the third end node E 611 receives the (NR, W₂) message, the third end node E 611 may recognize that the fourth end node F 612 separate from the third end node E 611 cancels the LoP associated with the second working path W₂. In such a case, the third end node E 611 may suspend transmitting of the (NR, W₂) message, and transmit the (NR, 0) message which is the initial state message to the fourth end node F 612. When the fourth end node F 612 receives the (NR, 0) message, the fourth end node F 612 may verify that the LoP between the both end nodes 611 and 612 is cancelled, transmit the (NR, 0) message as a response message in response to the cancellation and suspend transmitting the (NR, W₂) message. However, as described with reference to FIG. 5, when data traffic associated with the first working path W₁ is still being transmitted and received, the first node C 621 and the second node D 622, which are shared nodes in a protection path, may transmit the (SF, W₁) message instead of the (NR, 0) message.

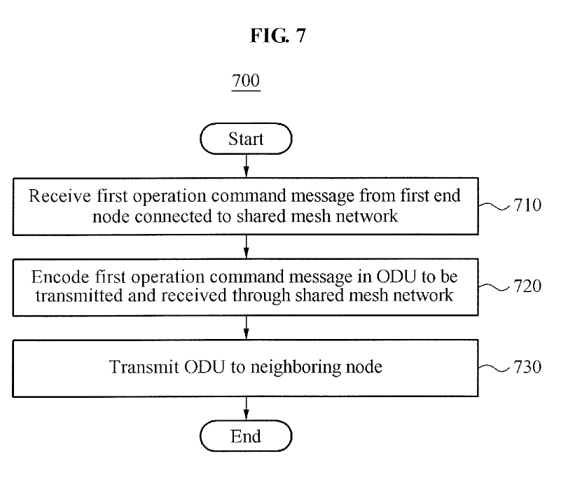

FIG. 7 is a flowchart illustrating a method 700 of performing protection switching by a first node included in a shared mesh network according to an embodiment. Referring to FIG. 7, the method 700 includes operation 710 of receiving a first operation command message from a first end node connected to the shared mesh network, operation 720 of encoding the first operation command message in an ODU to be transmitted and received through the shared mesh network, and operation 730 of transmitting the ODU to a neighboring node.

In operation 710, the first operation command message is received from the first end node connected to the shared mesh network. In detail, the shared mesh network may include a plurality of communication resources and a plurality of nodes to provide an environment in which protection switching is performed for a plurality of working paths. When data traffic associated with a working path different from a working path including the first end node is transmitted and received, and thus a communication resource of the shared mesh network is occupied, the first end node may transmit the first operation command message to the first node. The first end node may transmit, to the first node, a connection identifier field value associated with the working path along with the first operation command message.

In operation 720, the first operation command message is encoded in the ODU to be transmitted and received through the shared mesh network. In an example, operation 720 may relate to encoding the first operation command message in a high order ODU. In addition, operation 720 may also relate to encoding the first operation command message in an APS/PCC field of the high order ODU.

In operation 730, the ODU is transmitted to the neighboring node. In an example, operation 730 may relate to transmitting the ODU to a second end node corresponding to the first end node. In another example, operation 730 may relate to transmitting the ODU to a second node included in the shared mesh network. Here, similar to the first node, the second node is a node included in the shared mesh network and configuring at least one protection path.

The method 700 may further include an operation of receiving, from the neighboring node, a response message corresponding to the first operation command message. In addition, the method 700 may further include an operation of transmitting the response message to the first end node. In such a case, the operation of receiving the response message may relate to receiving, as the response message, any one of an initial state message and a second operation command message corresponding to the first operation command message.

The components or units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device.

The method described according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tapes; optical media such as CD ROMs and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A communication terminal configured to transmit and receive data traffic associated with a first working path, the communication terminal comprising:
a processor configured to encode, in an optical channel data unit (ODU) comprising the data traffic, a first operation command message to be received from a first end node; and
a communicator configured to transmit the ODU to a neighboring node, and
wherein the first end node is present in a second working path.

2. The communication terminal of claim 1, wherein the processor is configured to encode, in the ODU, a connection identifier field value associated with the second working path.

3. The communication terminal of claim 1, wherein the communicator is configured to receive, as the first operation command message, any one of a lockout of protection (LoP) message, an exercise (EXER) message, a reverse request (RR) message, and a no request (NR) message.

4. The communication terminal of claim 1, wherein the communicator is configured to transmit the ODU to a second end node present in the second working path.

5. The communication terminal of claim 4, wherein the communicator is configured to receive a second operation command message corresponding to the first operation command message from the second end node, and transmit the second operation command message to the first end node present in the second working path.

6. The communication terminal of claim 1, wherein the processor is configured to encode the first operation command message in a high order ODU.

7. The communication terminal of claim 6, wherein the processor is configured to encode the first operation command message in an automatic protection switching/protection communication channel (APS/PCC) field of the high order ODU.

8. A communication terminal, comprising:
a processor configured to extract a first operation command message from a first optical channel data unit (ODU) to be received, execute a command corresponding to the extracted first operation command message, and encode a response message corresponding to the first operation command message in a second ODU; and
a communicator configured to transmit the second ODU to a node, and
wherein the node is comprised in a shared mesh network for protection switching of a plurality of working paths, and the first ODU is to be received from the node.

9. The communication terminal of claim 8, wherein the processor is configured to encode, as the response message in the second ODU, a second operation command message corresponding to the first operation command message.

10. The communication terminal of claim 9, wherein the processor is configured to encode, in the second ODU, a connection identifier field value associated with the second operation command message.

11. The communication terminal of claim 8, wherein the processor is configured to encode, in the second ODU, an initial state message as the response message.

12. The communication terminal of claim 11, wherein the processor is configured to encode, in the second ODU, a connection identifier field value indicating all of the working paths.

13. A method of performing protection switching by a first node comprised in a shared mesh network, the method comprising:
receiving a first operation command message from a first end node connected to the shared mesh network;
encoding the first operation command message in an optical channel data unit (ODU) to be transmitted and received through the shared mesh network; and
transmitting the ODU to a neighboring node.

14. The method of claim 13, wherein the transmitting comprises transmitting the ODU to a second end node corresponding to the first end node.

15. The method of claim 13, wherein the transmitting comprises transmitting the ODU to a second node comprised in the shared mesh network.

16. The method of claim 13, further comprising:
encoding, in the ODU, first data traffic associated with a first working path for which the protection switching is performed through the shared mesh network.

17. The method of claim 13, wherein the encoding comprises:
encoding the first operation command message in a high order ODU.

18. The method of claim 17, wherein the encoding comprises:
encoding the first operation command message in an automatic protection switching/protection communication channel (APS/PCC) field of the high order ODU.

19. The method of claim 13, further comprising:
receiving a response message corresponding to the first operation command message from the neighboring node; and
transmitting the response message to the first end node.

20. The method of claim 19, wherein the receiving of the response message comprises:
receiving, as the response message, any one of an initial state message and a second operation command message corresponding to the first operation command message.
